(19) United States
(12) Patent Application Publication
(10) Pub. No.: US 2024/0282145 A1
(43) Pub. Date: Aug. 22, 2024

(54) EMOTION ACQUISITION DEVICE, EMOTION ACQUISITION METHOD, AND STORAGE MEDIUM

(71) Applicant: HONDA MOTOR CO., LTD., Tokyo (JP)

(72) Inventor: Randy Gomez, Wako-shi (JP)

(21) Appl. No.: 18/581,420

(22) Filed: Feb. 20, 2024

(30) Foreign Application Priority Data
Feb. 22, 2023 (JP) 2023-026244

(51) Int. Cl. G06V 40/16; G06V 10/82

(52) U.S. Cl. CPC G06V 40/174; G06V 10/82; G06V 40/168

(57) ABSTRACT

An emotion acquisition device includes an image capturing unit that acquires a human facial expression, a conversion unit that converts the human facial expression acquired by the image capturing unit into a continuous value indicating a human emotion, and an emotion estimation unit that maps the continuous value converted by the conversion unit to estimate an emotion of a target person.

### CROSS-REFERENCE TO RELATED APPLICATION

Priority is claimed on Japanese Patent Application No. 2023-026244, filed Feb. 22, 2023, the content of which is incorporated herein by reference.

### BACKGROUND OF THE INVENTION

### Field of the Invention

The present invention relates to an emotion acquisition device, an emotion acquisition method, and a storage medium.

### Description of Related Art

In recent years, there has been progress in the development of robots that can communicate with humans. Such robots are required to learn emotional actions (see, for example Patent Document 1). In the related art, it has been proposed to learn emotional actions using, for example, demonstration by a person (see, for example Non-Patent Document 1) or explicit feedback through keyboard buttons or mouse clicks.
[Patent Document 1] Japanese Unexamined Patent Application, First Publication No. 2022-29599
[Non-Patent Document 1] M. E. Taylor, H. B. Suay, and S. Chernova, “Integrating reinforcement learning with human demonstrations of varying ability,” in Proceedings of the 10th International Conference on Autonomous Agents and Multiagent Systems (AAMAS), pp. 617-624, Citeseer, 2011.

### SUMMARY OF THE INVENTION

However, in the related art, it is difficult to acquire accurate human emotions.

The present invention was contrived in view of the above problem, and an object thereof is to provide an emotion acquisition device, an emotion acquisition method, and a storage medium that make it possible to acquire accurate human emotions.

In order to solve the above problem and achieve such an object, the present invention adopts the following aspects.

(1) According to an aspect of the present invention, there is provided an emotion acquisition device including: an image capturing unit that acquires a human facial expression; a conversion unit that converts the human facial expression acquired by the image capturing unit into a continuous value indicating a human emotion; and an emotion estimation unit that maps the continuous value converted by the conversion unit to estimate an emotion of a target person.

(2) In the above aspect (1), the emotion estimation unit may estimate an emotion of a target person by mapping continuous values using Russell's emotional circle model.

(3) In the above aspect (1) or (2), the conversion unit may use a CNN network to extract a feature amount of an image which is a continuous value from the image of the acquired human facial expression.

(4) In the above aspect (3), the emotion estimation unit may input the continuous value indicating the human emotion converted by the conversion unit into an RNN network to obtain a reward depending on whether the facial expression of the target person is positive or negative.

(5) In any one of the above aspects (1) to (4), the emotion estimation unit may update a Q value in Q-learning using the following equation each time the human emotion is acquired,

$${Q ( {s}_{t} , {a}_{t} )}_{new} = {Q ( {s}_{t} , {a}_{t} )}_{old} + α ( {R}_{h} + γ {max}_{a} Q ( {s}^{′} , a ) - Q ( {s}_{t} , {a}_{t} ) )$$

where sₜ and aₜ are an emotional state detected by and an emotional action selected by a robot at time step t, respectively, α is a learning rate, Rₕ is a reward and predicted implicit feedback, and s′ is a next state.

(6) In the above aspect (5), the reward Rₕ may be calculated by the following equation,

$${R}_{h} = \{ \begin{matrix}\frac{2 - [ {( V - 1 )}^{2} + {( A - 1 )}^{2} ]}{2} & V > 0 , A > 0 \\ - \frac{1}{2} * \frac{2 - [ {V}^{2} + {( A - 1 )}^{2} ]}{2} & V \leq 0 , A > 0 \\ - \frac{2 - [ {V}^{2} + {A}^{2} ]}{2} & V \leq 0 , A \leq 0 \\ \frac{1}{2} * \frac{2 - [ {( V - 1 )}^{2} + {A}^{2} ]}{2} & V > 0 , A \leq 0\end{matrix}$$

where V is an estimated valence and A is an estimated arousal value.

(7) According to an aspect of the present invention, there is provided an emotion acquisition method including: causing an image capturing unit to acquire a human facial expression; causing a conversion unit to convert the human facial expression acquired by the image capturing unit into a continuous value indicating a human emotion; and causing an emotion estimation unit to map the continuous value converted by the conversion unit to estimate an emotion of a target person.

(8) According to an aspect of the present invention, there is provided a storage medium having a program stored therein, the program causing a computer of an emotion acquisition device to: acquire a human facial expression; convert the acquired human facial expression into a continuous value indicating a human emotion; and map the converted continuous value to estimate an emotion of a target person.

According to the above aspects (1) to (8), it is possible to acquire accurate human emotions.

### BRIEF DESCRIPTION OF THE DRAWINGS

FIG. 1 is a diagram illustrating a learning process of a robot based on implicit feedback predicted from human facial expressions according to a first embodiment.

FIG. 2 is a diagram illustrating an example of the external shape of the robot according to the embodiment.

FIG. 3 is a diagram illustrating an example in which emotional expressions of the robot according to the embodiment are presented in animation.

FIG. 4 is a diagram illustrating an overview of a structure of a CNN-RNN model for predicting implicit evaluation feedback based on human reactive facial expressions according to the first embodiment.

FIG. 5 is a diagram illustrating a configuration example of a robot equipped with an emotion acquisition device according to the first embodiment.

FIG. 6 is a diagram illustrating an overview of human emotional states in two evaluation conditions and emotional actions corresponding thereto which can be selected and executed by the robot.

FIG. 7 is a diagram illustrating examples of gestural expressions and facial expressions.

FIG. 8 is a diagram illustrating a learning curve from predicted implicit facial feedback and a learning curve based on learning from explicit and random feedback.

FIG. 9 is a diagram illustrating normalized learning curves for each human emotional state based on facial expressions in the learning process.

FIG. 10 is a diagram illustrating normalized learning curves for each human emotional state based on gestural expressions in the learning process.

FIG. 11 is a diagram illustrating Russell's emotional circle model.

FIG. 12 is a diagram illustrating a configuration example of a robot equipped with an emotion acquisition device according to a second embodiment.

FIG. 13 shows an example of a processing procedure during learning performed by the robot according to the second embodiment.

FIG. 14 is a heat map with 40 interactions and a heat map with 80 interactions.

FIG. 15 is a heat map with 120 interactions and a heat map with 160 interactions.

FIG. 16 is a diagram illustrating a configuration example of an implicit feedback module according to the second embodiment.

FIG. 17 is a diagram illustrating the mean square error and concordance correlation coefficient of implicit feedback prediction in a case where different numbers of latent components are retained in training, validation, and test datasets.

FIG. 18 is a diagram illustrating the average number of emotional states with optimal action and results of Welch's t-test for learning from explicit feedback, predicted implicit feedback, and random feedback.

FIG. 19 is a diagram illustrating learning curves in which the emotional states of facial expressions and gestures are learned from predicted implicit feedback.

FIG. 20 is a diagram illustrating the proportion of positive and negative implicit feedback during a training process in two conditions using the emotional states of faces and gestures.

FIG. 21 is a diagram illustrating a Pearson correlation between mean evaluation, standard deviation, mean absolute error, and Haru's learning performance for each condition.

### DETAILED DESCRIPTION OF THE INVENTION

Hereinafter, an embodiment of the present invention will be described with reference to the accompanying drawings. In the drawings used in the following description, the scale of each member is appropriately changed in order to make each member recognizable.

In all the drawings used to describe the embodiment, elements having the same functions are denoted by the same reference numerals and signs, and thus description thereof will not be repeated.

In addition, the wording “on the basis of XX” used in this specification means “based on at least XX,” and also includes cases based on other elements in addition to XX. The wording “on the basis of XX” also includes a case based on an arithmetic operation or processing being performed on XX without being limited to a case in which XX is used directly. The term “XX” refers to any element (for example, any information).

### First Embodiment

First, an overview of a learning process in the present embodiment will be described.

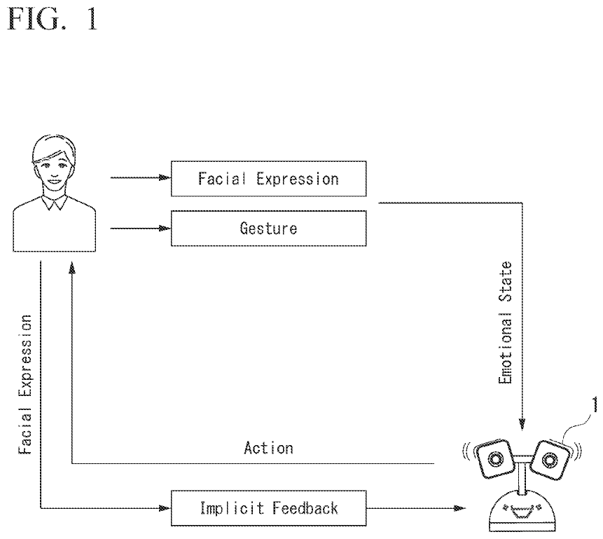

FIG. 1 is a diagram illustrating a learning process of a robot based on implicit feedback predicted from human facial expressions according to the present embodiment.

In the present embodiment, for example, a robot 1 understands the current emotional state of a person, selects an emotional action in accordance with the learned policy, and presents it to a user. The robot 1 is, for example, a communication robot. As will be described later, the robot 1 is equipped with an image capturing device, a microphone, and the like. An environment sensor such as an image capturing device is provided in the environment in which acquisition is to be performed. A person responds to actions presented by the robot 1 with facial expressions, gestures, voice, and the like.

The robot 1 acquires information on facial expressions which are reactions of a person to emotional actions presented by the robot 1, and updates the acquired facial expression information using the information as a reward.

The robot 1 performs learning in real time, that is, learns from continuous interaction with a person. In the learning of the robot 1, there is no need for a person to provide feedback as in the past using a keyboard or the like, that is, natural human reactions such as facial expressions are used for learning.

### (Example of External Shape of Communication Robot)

Next, an example of the external shape of the robot 1 will be described.

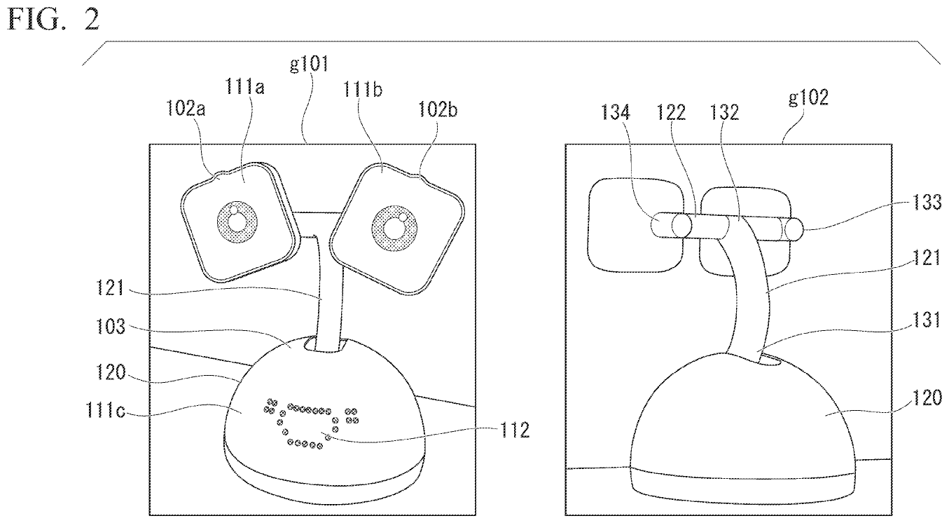

FIG. 2 is a diagram illustrating an example of the external shape of the robot according to the embodiment. In FIG. 2, a front view g101 and a side view g102 are diagrams illustrating an example of the external shape of the robot 1 according to the embodiment. The robot 1 includes, for example, three display units 111 (an eye display unit 111a, an eye display unit 111b, and a mouth display unit 111c). In the example of FIG. 2, an image capturing unit 102a is attached to the upper portion of the eye display unit 111a, and an image capturing unit 102b is attached to the upper portion of the eye display unit 111b. The eye display units 111a and 111b are equivalent to human eyes, and present images or image information equivalent to human eyes. The screen size of the eye display unit 111a and the eye display unit 111b is, for example, 3 inches. A speaker 112 is attached to a housing 120 near the mouth display unit 111c that displays an image which is equivalent to a human mouth. The mouth display unit 111c is composed of, for example, a plurality of LEDs (light-emitting diodes), each of which can be addressed and turned on and off individually. A sound collection unit 103 is attached to the housing 120.

The robot 1 includes a boom 121. The boom 121 is movably attached to the housing 120 through a movable portion 131. A horizontal bar 122 is rotatably attached to the boom 121 through a movable portion 132.

The eye display unit 111a is rotatably attached the horizontal bar 122 through a movable portion 133, and the eye display unit 111b is rotatably attached thereto through a movable portion 134. The external shape of the robot 1 shown in FIG. 2 is an example, and there is no limitation thereto.

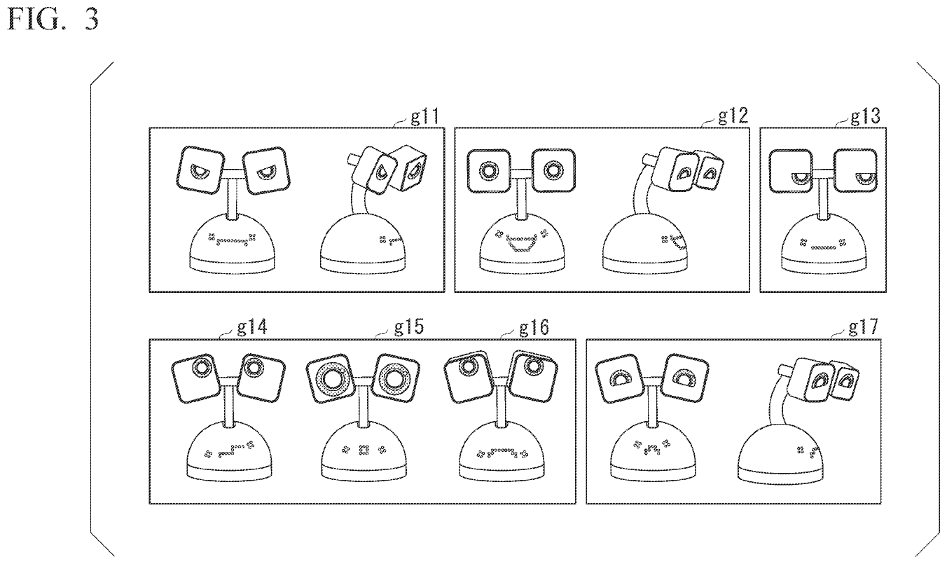

FIG. 3 is a diagram illustrating an example in which emotional expressions of the robot according to the embodiment are presented in animation. As shown in FIG. 3, the robot 1 presents emotional expressions by changing the animation displayed on the display unit 111 (the eye display unit 111a, the eye display unit 111b, and the mouth display unit 111c).

Animation examples for reference signs g11 to g17 are “angry,” “ecstatic,” “disinterested,” “confused,” “blushing,” “sad,” and “sympathetic.”

The emotional expressions and animations shown in FIG. 3 are merely examples, and there is no limitation thereto. The emotional expressions may be other than those shown in FIG. 3, and the animation of each emotional expression may be different from that shown in FIG. 3. During each emotional expression, the angle and position of the display unit 111 may be changed as shown in FIG. 3, the angle of the boom 121 may be changed, or sound signals may be output together.

### Definition

Next, states, actions, rewards, and the like used in the present embodiment will be defined.

Almost all reinforcement learning problems can be modeled as a Markov decision process represented by the tuple <S, A, T, R, γ>. S and A are a set of possible states and actions of the agent. T is a transition probability, which is a probability of the agent transitioning from the current state s to the next state s′. R is a reward function and represents a reward probability when the agent executes action a and transitions from state s to s′. γ is a discount factor and represents the influence of an immediate reward and a future reward. The agent's action is represented by a policy π(s). S→A maps states to possible actions. The goal of the reinforcement learning agent is to learn a course of action that maximizes the total reward received from the environment.

In the present embodiment, for example, Q-learning is used as the reinforcement learning algorithm. The robot 1 acquires a user's current emotional state (facial emotion or gesture) and selects an action with the largest Q value using the greedy strategy. Next, the action selected by the robot 1 is executed, and then the user gives feedback R in accordance with his/her preference. When the action selected by the robot 1 is desirable, the user will show a positive reaction with his/her facial expression, and the Q value of the selected action will increase. When the same or similar human emotional state is detected, the robot 1 is more likely to select the action again. On the other hand, in a case where the action selected by the robot 1 is not desirable, the user performs negative feedback, and the Q value of the selected action will decrease. When the same human emotional state is also detected next time, the robot 1 is more likely to attempt another action.

The robot 1 updates the Q value using the following equation (1) each time it receives feedback from a person.

$${Q ( {s}_{t} , {a}_{t} )}_{new} = {Q ( {s}_{t} , {a}_{t} )}_{old} + α ( {R}_{h} + γ {max}_{a} Q ( {s}^{′} , a ) - Q ( {s}_{t} , {a}_{t} ) ) \qquad ( 1 )$$

In Expression (1), sₜ and aₜ are an emotional state detected by and an emotional action selected by the robot 1 at time step t, respectively, a is a learning rate, Rₕ is predicted implicit feedback, and s′ is the next state.

At the next time step t+1, when a new human emotional state is detected, the robot 1 performs an emotional routine action with the largest Q value as in the following equation (2).

$$π ( s ) : a ← {arg max}_{a ∈ A} Q ( {s}_{t + 1} , a ) \qquad ( 2 )$$

In Expression (2), A is a set of emotional actions that can be executed by the robot 1, and sₜ₊₁ is the next detected emotional state. This cycle is repeated until the robot 1 learns the optimal action desired for all detected human emotional states.

### (Comparison of Reward)

Next, rewards are compared. Some conventional techniques classify facial expressions using a classification module trained in advance, but in many cases, there are many facial expressions that do not belong to a specific category, and there are facial expressions (for example, anger and disgust) which are understood differently by different people.

### (Implicit Feedback Prediction)

When the robot 1 takes an action, the user's facial expression changes accordingly to show the user's degree of satisfaction with the emotional action of the robot 1. In the present embodiment, information on the user's facial expression is extracted as implicit feedback, and it is possible to learn the action of the robot 1 according to the user's preferences. In this case, the non-expert user does not need to learn complicated learning rules in advance.

The robot 1 can learn emotional action according to the user's preferences through natural interactions. In the present embodiment, the captured raw facial expression images are directly mapped to human evaluation feedback end-to-end and are used to form the emotional action of the robot 1 in accordance with the user's preferences. In the present embodiment, emotions are estimated from facial expression images using, for example, a convolutional neural network (CNN)-recurrent neural network (RNN) to predict implicit feedback.

In the following example, this model was trained and evaluated using the GENKI-4 k emotion dataset having 15,710 images after data expansion (http://mplab.ucsd.edu, “The MPLab GENKI Database, GENKI-4K Subset”). All facial expressions included in the dataset are divided into two categories.

For example, they can be categorized as “smiling” and “not smiling.” All “happy” emotions are included in a “smiling” group, while “unhappy” emotions such as “anger,” “disinterest,” and “sadness” are classified into a “not smiling” group.

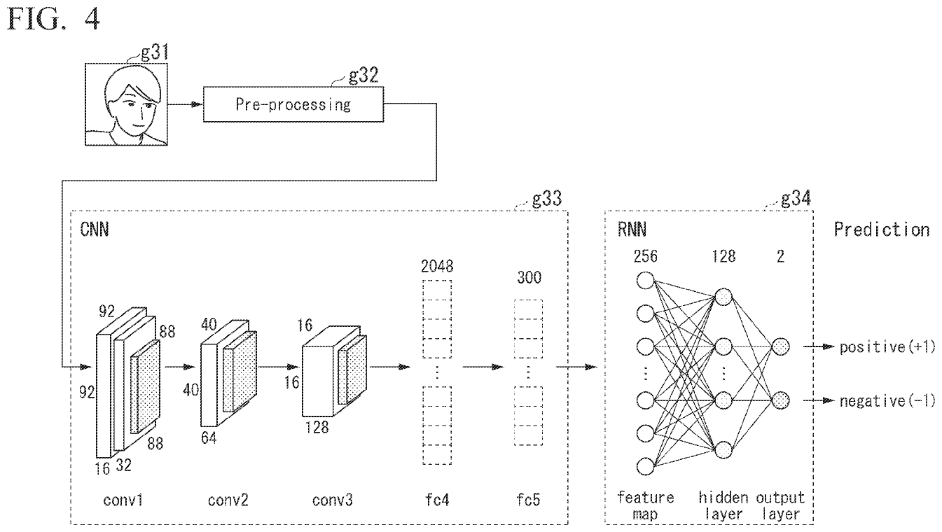

Next, an overview of the structure of a model will be described. FIG. 4 is a diagram illustrating an overview of the structure of a CNN-RNN model for predicting implicit evaluation feedback based on human reactive facial expressions according to the present embodiment.

In prediction, an emotional image g31 is first pre-processed (g32) (for example, cut out, rotated, or the like) and transferred to a designed CNN network (g33) to extract image features. An RNN network (g34) then predicts a corresponding reward in accordance with the extracted features.

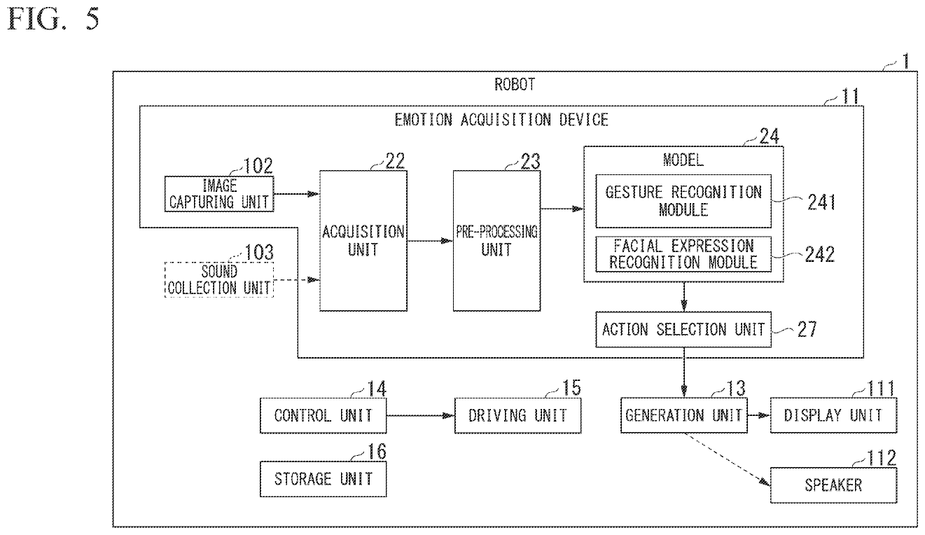

In a case where the model is trained, the emotions of the “smiling” and “not smiling” groups are labeled as “positive” and “negative” feedback, respectively, as shown in FIG. 5. The ratio of the training set to the test set is, for example, 4:1. The final prediction accuracy was 80%.

The CNN network (g33) is composed of, for example, a convolution layer with a first layer having filter dimensions of 92×92×16 and 88×88×32, a convolution layer with a second layer having filter dimensions of 40×40×64, and a convolution layer with a third layer having filter dimensions of 16×16×128. The input of a fourth layer is fully connected with 2048, and the input of a fifth layer is fully connected with 300. The dimensions and the number of inputs described above are merely examples, and there is no limitation thereto.

The RNN network (g34) is composed of, for example, an 8-bit (256) feature map, a 4-bit (128) hidden layer, and a 1-bit (2) output layer. The layer configuration and the number of bits are merely examples, and there is no limitation thereto.

The output of this CNN-RNN model is a reward, where a positive reward is, for example, “+1” and a negative reward is, for example, “−1.”

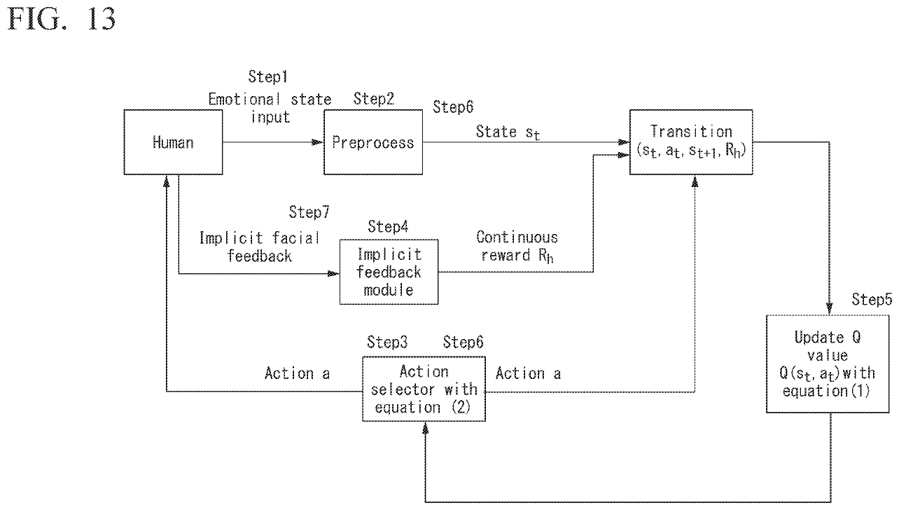

An emotion acquisition device 11 estimates a person's facial expression on the basis of the output of such a CNN-RNN portion. For example, the emotion acquisition device 11 may consider that the estimation is correct if it estimates the person to be angry and a positive output is selected, and may consider that the estimation is incorrect if it estimates the person to be angry and a negative output is selected. Alternatively, the emotion acquisition device 11 may select and evaluate an action with a maximum Q value in Step3 (FIG. 13) as described in the second embodiment, repeat this to cause an emotion recognition module to learn an optimal action, and then use the trained emotion recognition module to estimate the emotion and select the action.

### (Configuration Example of Robot and Emotion Acquisition Device)

Next, a configuration example of the robot 1 equipped with an emotion acquisition device will be described. FIG. 5 is a diagram illustrating a configuration example of the robot equipped with an emotion acquisition device according to the present embodiment.

As shown in FIG. 5, the robot 1 includes, for example, the emotion acquisition device 11, the sound collection unit 103, a generation unit 13, the display unit 111, the speaker 112, a control unit 14, a driving unit 15, and a storage unit 16.

The emotion acquisition device 11 includes, for example, an image capturing unit 102, an acquisition unit 22, a pre-processing unit 23, a model 24, and an action selection unit 27. The sound collection unit 103 may be included in the emotion acquisition device 11.

The sound collection unit 103 is, for example, a microphone array including M (M is an integer equal to or greater than 2) microphones.

As described with reference to FIG. 2, the display unit 111 includes the eye display unit 111a, the eye display unit 111b, and the mouth display unit 111c. The display unit 111 displays an image or animation generated by the generation unit 13.

The speaker 112 outputs an acoustic signal generated by the generation unit 13.

The control unit 14 drives each unit of the robot 1 through the driving unit 15.

The driving unit 15 includes, for example, an actuator and a driving circuit. The driving unit 15 drives each unit of the robot 1 in accordance with control of the control unit 14.

The storage unit 16 stores, for example, mathematical formulas, thresholds, and programs used by the emotion acquisition device 11, programs used to control the robot 1, and the like.

The image capturing unit 102 may be attached to the robot 1 or may be grounded in the environment where the robot 1 and the user are present. The image capturing unit 102 is, for example, an RBG camera, an RGBD camera that can also obtain depth information, or the like. The information on an image captured by the image capturing unit 102 is an image including the user's face. The image may be any one of a still image, a series of still images, or a moving image.

The acquisition unit 22 acquires information on an image captured by the image capturing unit 102. The acquisition unit 22 acquires an M-channel acoustic signal collected by the sound collection unit 103.

The pre-processing unit 23 performs predetermined pre-processing on the image information acquired by the acquisition unit 22. Examples of pre-processing include image cutting-out, image rotation, image luminance, contrast correction, and the like.

The model 24 includes, for example, a gesture recognition module 241 and a facial expression recognition module 242. The gesture recognition module 241 uses the joint positions of the user tracked by a depth sensor included in the image capturing unit 102 to classify joint features using a trained CNN network. The facial expression recognition module 242 is the CNN-RNN model described above. The facial expression recognition module 242 inputs the pre-processed image to the trained CNN network to extract a feature amount. The facial expression recognition module 242 inputs the extracted feature amount to the trained RNN network to estimate whether the user's facial expression is positive or negative.

The action selection unit 27 updates the Q value estimated by the emotion acquisition device 11 using Expression (1) described above. The action selection unit 27 selects an action for the user's facial expression using the updated Q value and Expression (2) described above.

The generation unit 13 generates an animation or an image to be displayed on the display unit 111 in accordance with the selected action. The storage unit 16 stores the selected action and the generated animation in association with each other. The generation unit 13 may generate an acoustic signal to be output from the speaker 112 on the basis of the estimation result estimated by the emotion acquisition device 11. The animation of the facial expression presented by the robot 1 and an example of the action performed by the robot 1 will be described later.

Here, an example of learning method of the model 24 and the selectivity of action using the trained model 24 will be described.

During learning, the pre-processed image information is input to the model 24 from the pre-processing unit 23. The facial expression recognition module 242 of the model 24 extracts a feature amount from the input image information using the CNN network, inputs the extracted feature amount to the RNN network, and obtains a reward for the action performed by the robot 1 (whether it is a negative facial expression or a positive facial expression). The facial expression recognition module 242 updates the Q value using the obtained reward and Expression (1). Further, the model 24 selects an action to be presented next time during learning by selecting an action with a maximum Q value. By repeating such a process, the emotion acquisition device 11 performs learning of the model 24.

At the time of action selection, the emotion acquisition device 11 presents a presented action determined in advance on the basis of, for example, the result of voice recognition of the content of the user's utterance. The emotion acquisition device 11 acquires the facial expression image of the user in response to the presented action, uses the trained model 24 to obtain a reward indicating whether the user's implicit feedback is positive or negative, and uses the obtained reward to select the next action to be presented.

### (Evaluation and Evaluation Results)

Next, the results of evaluating the method of the present embodiment will be described.

Two evaluation conditions were set to evaluate whether the robot 1 was able to learn a simple empathic and emotional action through interaction with humans and adapt to the user's preferences. In each evaluation condition, one modality was used to represent the human emotional state. In the first condition, human facial expressions were used to represent human emotional states because both human facial expressions and gestures can indicate emotions. In the second condition, human gestural expressions were used as expressions of human emotional states.

In both conditions, the user performs reactive facial feedback as implicit evaluation feedback, and the robot 1 acquires a facial expression which is this evaluation feedback to learn an emotional action. In this case, the user's state and feedback are detected and transferred by a separate module (that is, the robot 1 does not use the user's facial emotional state as implicit facial feedback).

The facial expression recognition module uses a convolutional neural network trained in advance to recognize the emotional state of a human face. The gesture recognition module uses the joint positions of the user tracked by a depth sensor to classify joint features using a CNN architecture.

Understanding the current emotional state of the user typically requires a large amount of iteration and data.

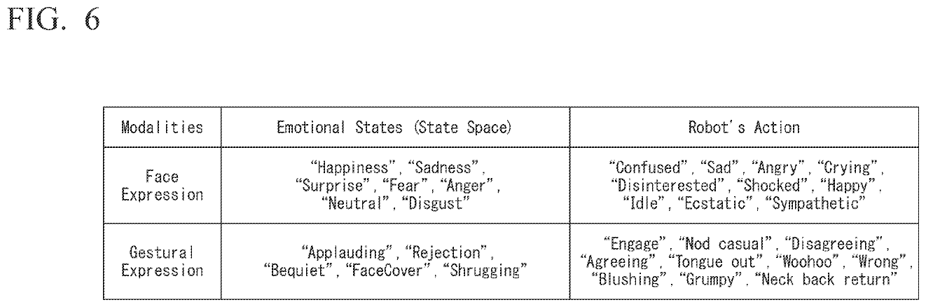

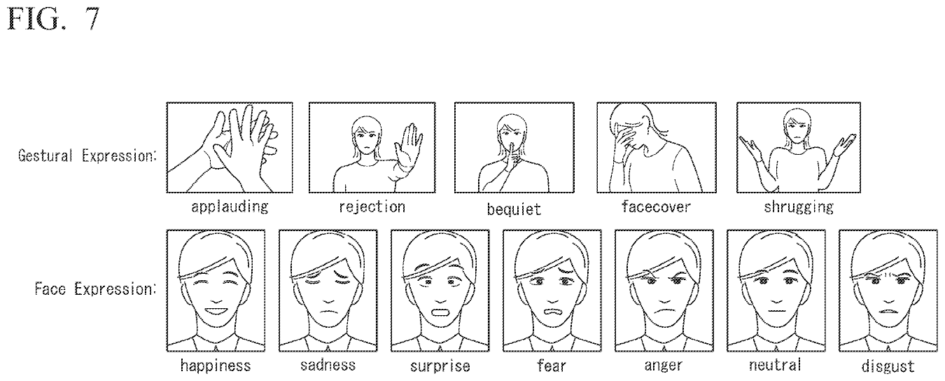

For this reason, in the evaluation, the state space of the two conditions was limited to several emotional states as shown in FIG. 6. FIG. 6 is a diagram illustrating an overview of human emotional states in two evaluation conditions and emotional actions corresponding thereto which can be selected and executed by the robot. FIG. 7 is a diagram illustrating examples of gestural expressions and facial expressions. As shown in FIG. 6, in the first condition, seven facial expressions of “happiness,” “sadness,” “surprise,” “fear,” “anger,” “neutral,” and “disgust” were used as human emotional states. In the second condition, five gestural expressions of “applauding,” “rejection,” “bequiet,” “facecover,” and “shrugging” which are gestural expressions were used as human emotional states. The robot 1 can also move its drives or express emotions through sound, but ten types of emotion routine actions were designed for each condition on the basis of the common sense of emotional interaction between humans.

Next, examples of evaluation results will be described.

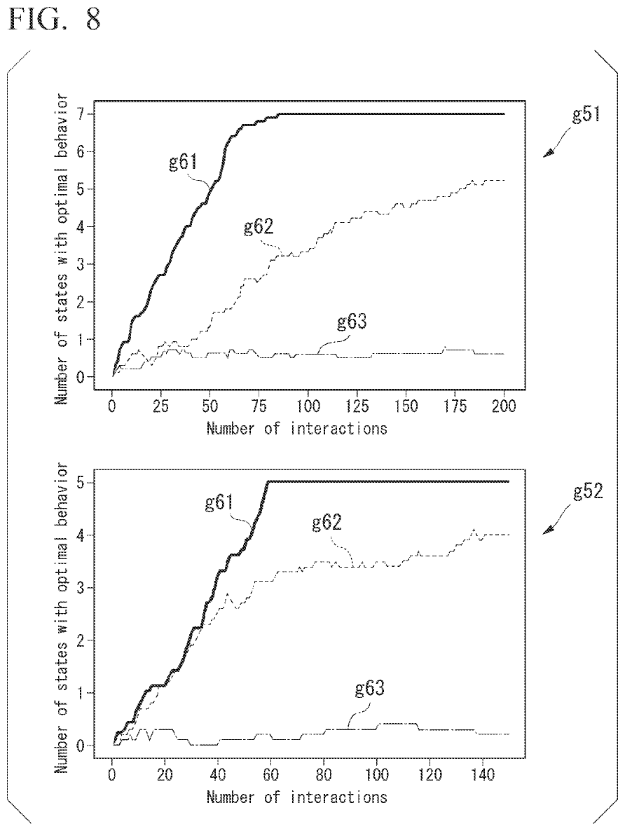

FIG. 8 is a diagram illustrating a learning curve from predicted implicit facial feedback and a learning curve based on learning from explicit and random feedback. Each learning curve is an average of data collected from ten participants in each condition with the exception of those for random feedback. In FIG. 8, the horizontal axis is the number of interactions, and the vertical axis is the number of times optimal behaviors were performed. A line g61 is a learning curve for explicit feedback, a line g62 is a learning curve for implicit feedback, and a line g63 is a learning curve for random feedback. In addition, the reference sign g51 indicates the case of the emotional state of the face, and g52 indicates the emotional state of the gesture.

The evaluation results in FIG. 8 show that learning performance increased rapidly in the case of explicit feedback, and stabilized after about 75 interactions in the case of the facial emotional state and after about 60 interactions in the case of the gestural emotional state.

In this way, the evaluation results showed that optimal emotional actions were obtained in all seven facial emotional states and five gestural emotional states. In the model of the present embodiment, optimal emotional actions could be acquired for five facial expressions and four gestural emotional states even in a case where interactions were further increased.

In the method of the present embodiment, learning from predicted implicit feedback is much better than random feedback (prediction accuracy 50%) indicating the worst scenario.

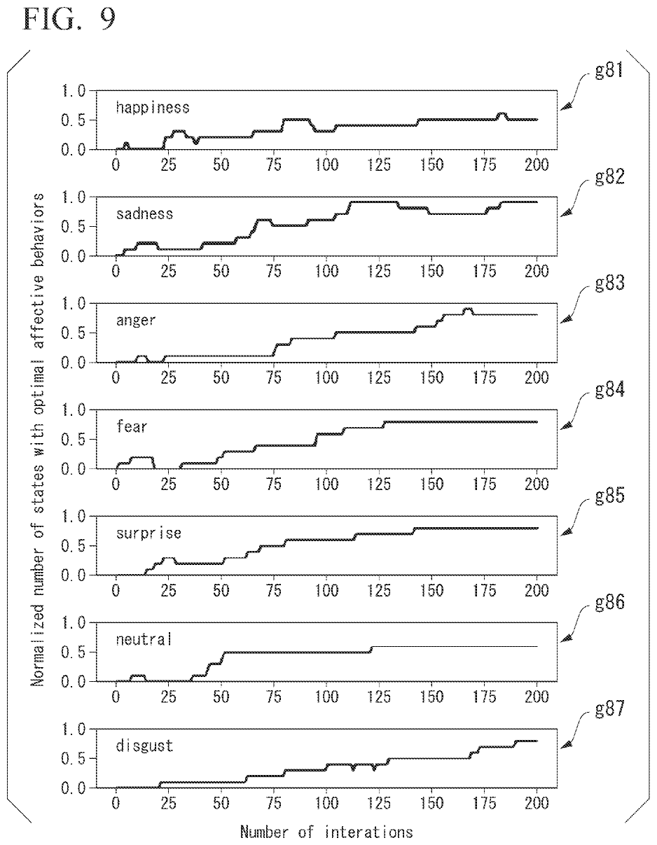

FIG. 9 is a diagram illustrating normalized learning curves for each human emotional state based on facial expressions in the learning process. The horizontal axis is the number of interactions, and the vertical axis is the normalized number of optimal behaviors. The reference sign g81 is “happiness,” the reference sign g82 is “sadness,” the reference sign g83 is “anger,” the reference sign g84 is “fear,” the reference sign g85 is “surprise,” the reference sign g86 is “neutral,” and the reference sign g87 is “disgust.”

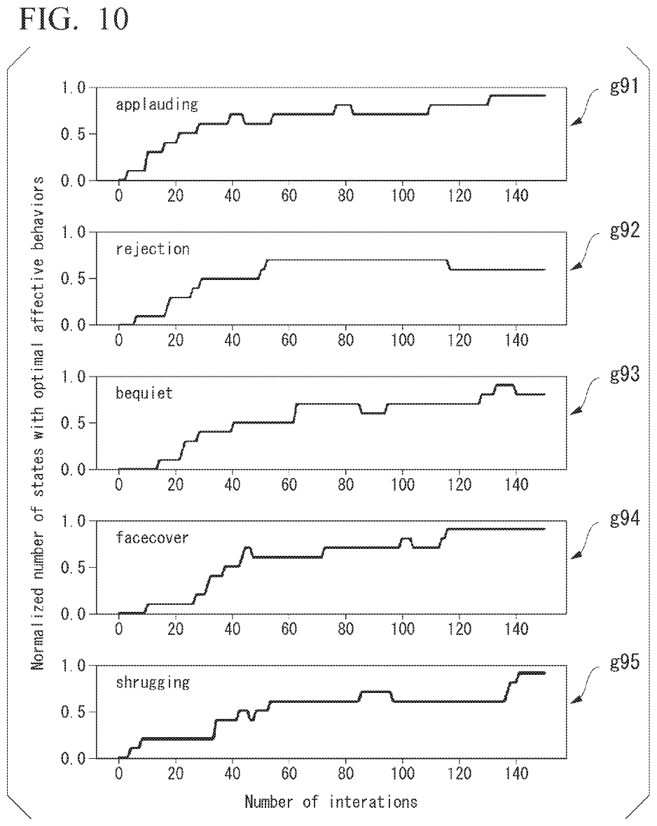

FIG. 10 is a diagram illustrating normalized learning curves for each human emotional state based on gestural expressions in the learning process. The horizontal axis is the number of interactions, and the vertical axis is the normalized number of optimal behaviors. The reference sign g91 is “applauding,” the reference sign g92 is “rejection,” the reference sign g93 is “bequiet,” the reference sign g94 is “facecover,” and the reference sign g95 is “shrugging.”

Each learning curve was averaged and normalized for data collected from ten participants in each condition.

As described above, in the present embodiment, the robot 1 is caused to learn appropriate emotional action reactions through interaction with humans. The robot 1 can learn from implicit feedback obtained from facial expressions and select the optimal action according to the user's preferences. According to the present embodiment, it is possible to eliminate the need for the user to learn the learning knowledge in advance while achieving performance equivalent to learning from explicit feedback.

### Second Embodiment

In the present embodiment, human-centered reinforcement learning is used to form the emotional action of the robot in which continuous rewards are predicted on the basis of feedback of received implicit facial expressions. In the present embodiment, the valence and arousal of feedback of the received implicit facial expressions are estimated using Russell's emotional circle model. According to the present embodiment, this makes it possible to more accurately describe the intensity of the user's emotion and the degree of satisfaction with the agent's action, and to more closely match a realistic interaction scenario.

### (Russell's Emotional Circle Model)

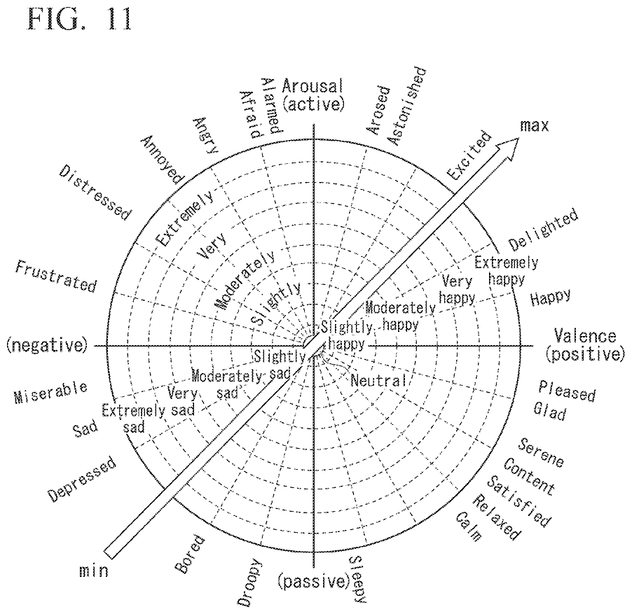

First, Russell's emotional circle model will be described. FIG. 11 is a diagram illustrating Russell's emotional circle model. Russell's circular structure model represents arousal using one axis. Arousal (active) is arousal or excitement, and passive is non-arousal or calmness. Valence (positive) is pleasure, and negative is displeasure. In this way, Russell's circular structure model shows that emotions corresponding to straight lines the center (neutral) represent opposite emotions.

The valence indicates the degree of pleasure or displeasure. The arousal indicates the degree of excitement or calmness.

In the present embodiment, a model (CNN-RNN model) that predicts continuous rewards is trained on the basis of the valence and arousal of the acquired implicit facial expression feedback.

Specifically, a prediction model was trained using the MorphSet dataset (see Reference Document 1). This dataset includes 166,382 images having valence and arousal annotations dimension with high dimensional consistency.
Reference Document 1; V. Vonikakis, N. Y. R. Dexter, and S. Winkler, “Morphset: Augmenting categorical emotion datasets with dimensional affect labels using face morphing,” in 2021 IEEE International Conference on Image Processing (ICIP), pp. 2713-2717, IEEE, 2021.

The reward Rₕ for the emotion of each image in the dataset was calculated as in the following equation (3) in accordance with valence and arousal estimated using Russell's emotional circle model.

$${R}_{h} = \{ \begin{matrix}\frac{2 - [ {( V - 1 )}^{2} + {( A - 1 )}^{2} ]}{2} & V > 0 , A > 0 \\ - \frac{1}{2} * \frac{2 - [ {V}^{2} + {( A - 1 )}^{2} ]}{2} & V \leq 0 , A > 0 \\ - \frac{2 - [ {V}^{2} + {A}^{2} ]}{2} & V \leq 0 , A \leq 0 \\ \frac{1}{2} * \frac{2 - [ {( V - 1 )}^{2} + {A}^{2} ]}{2} & V > 0 , A \leq 0\end{matrix} \qquad ( 3 )$$

In Expression (3), V is an estimated valence, and A is an estimated arousal value. As the valence and arousal become higher, the reward value increases. The rewards calculated using Expression (1) were used as labels for images in the dataset in learning of the prediction model. The ratio of a learning set, a verification set, and a test set is 7:2:1.

### (Configuration Example of Robot and Emotion Acquisition Device)

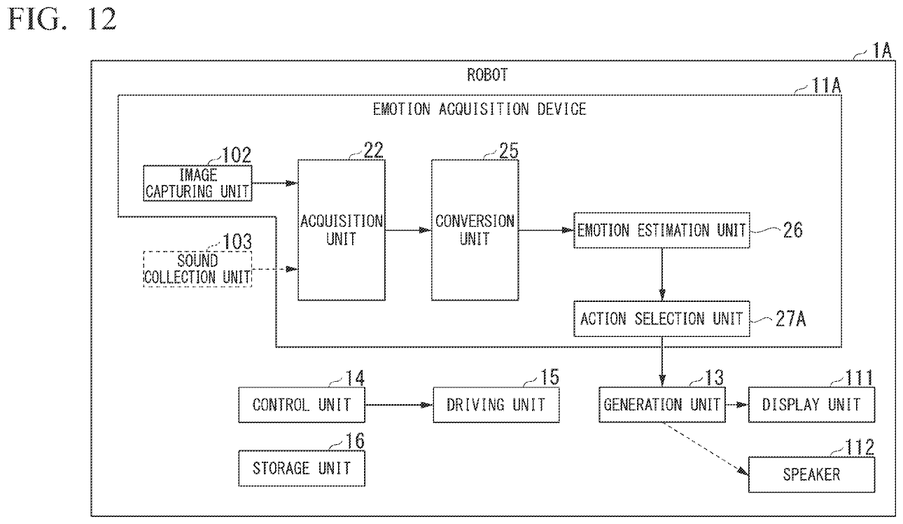

Next, a configuration example of a robot 1A equipped with an emotion acquisition device will be described. FIG. 12 is a diagram illustrating a configuration example of the robot equipped with an emotion acquisition device according to the present embodiment.

As shown in FIG. 12, the robot 1A includes, for example, the emotion acquisition device 11A, the sound collection unit 103, the generation unit 13, the display unit 111, the speaker 112, the control unit 14, the driving unit 15, and the storage unit 16.

The emotion acquisition device 11A includes, for example, the image capturing unit 102, the acquisition unit 22, a conversion unit 25, an emotion estimation unit 26, and an action selection unit 27A. The sound collection unit 103 may be included in the emotion acquisition device 11.

The conversion unit 25 converts human facial expressions captured by the image capturing unit 102 into continuous values indicating human emotions.

The emotion estimation unit 26 maps the continuous values converted by the conversion unit 25 and estimates the emotion of a target person. As described above, the results estimated by the emotion estimation unit 26 are, for example, “smiling,” “not smiling,” “anger,” “disinterest,” “sadness,” and the like.

The action selection unit 27A selects and executes an action (emotional action) with an action selector using Expression (2). Thereby, the action selection unit 27A selects an action a with a maximum Q value from among all possible actions in the state sₜ. A is a set of all possible actions in the state s. The action selection unit 27A may be provided with the emotion estimation unit 26.

Here, processing performed by the conversion unit 25 and the emotion estimation unit 26 will be further described.

The conversion unit 25 acquires information on the captured image through the acquisition unit 22. The conversion unit 25 performs pre-processing (such as, for example cutting-out or rotation) on the acquired image information. The conversion unit 25 uses a CNN network to extract feature amounts (continuous values indicating human emotions) of the pre-processed image.

The emotion estimation unit 26 obtains valence and arousal by mapping the continuous values converted by the conversion unit 25 to Russell's emotional circle model.

### (Processing Procedure)

Next, an example of a processing procedure performed by the emotion acquisition device 11A during learning will be described. FIG. 13 shows an example of a processing procedure during learning performed by the robot according to the present embodiment.

In the following description, an example in which Q-learning is used as a reinforcement learning algorithm will be described, but the algorithm to be used is not limited thereto, and other algorithms may be used.
(Step S1) The emotion acquisition device 11A starts by selecting a random action in order to initialize the Q values of all actions to zero.
(Step S2) The emotion acquisition device 11A acquires the current human emotion input indicated by facial expressions and gestures at time t, and performs pre-processing on the acquired information as the human emotional state sₜ.
(Step S3) The emotion acquisition device 11A selects and executes an action (emotional action) with an action selector using Expression (2). That is, the emotion acquisition device 11A selects an action a with a maximum Q value from among all possible action in the state sₜ.
(Step S4) The emotion acquisition device 11A acquires the result of the user observing the emotional action of the robot 1A and reacting with a facial expression according to the user's preferences. The emotion acquisition device 11A inputs the acquired facial expression information to an implicit feedback module to predict a continuous reward Rₕ.
(Step S5) The emotion acquisition device 11A updates the Q value Q (sₜ, aₜ) of the action aₜ executed in the state sₜ with the implicit continuous reward Rₕ predicted using Expression (3). That is, the emotion acquisition device 11A obtains a new Q value Q(sₜ, aₜ) by updating the old Q value Q(sₜ, aₜ) with the predicted implicit continuous reward Rₕ.

When the emotional action of the robot 1A is desirable, the user gives positive feedback through facial expressions. In this case, the Q value of the selected emotional action increases. In a case where the same emotional state is detected next time, the robot 1A selects the action with a high probability. If not, the user performs negative feedback and the Q value of the selected action decreases.
(Step S6) The emotion acquisition device 11A detects the user's new emotional state sₜ₊₁ at the next time t+1, and selects an action with the largest Q value in the state sₜ₊₁ using Expression (2). A is a set of all actions that can be executed by the emotion acquisition device 11A in the state sₜ₊₁.
(Step S7) A new cycle is started. A human provides new implicit facial feedback for the executed action in the new emotional state sₜ₊₁. The emotion acquisition device 11A predicts the continuous reward Rₕ, updates the Q value of the action selected in the state sₜ₊₁, and selects another action in a new state detected with the updated Q value.

This cycle is repeated until the emotion acquisition device 11A has learned the optimal action desired for all detected human emotional states. By repeating this cycle, the desired optimal action is learned for the detected human emotional state.

In the processing described above, the implicit feedback module is included in, for example, the conversion unit 25 and the emotion estimation unit 26.

When in use, the emotion acquisition device 11A predicts the continuous reward Rₕ by inputting the captured facial expression image to the implicit feedback module that has performed learning in the procedure described above. The emotion acquisition device 11A then estimates the emotion of a target person using the predicted continuous reward Rₕ.

Here, an example of the learning process will be described.

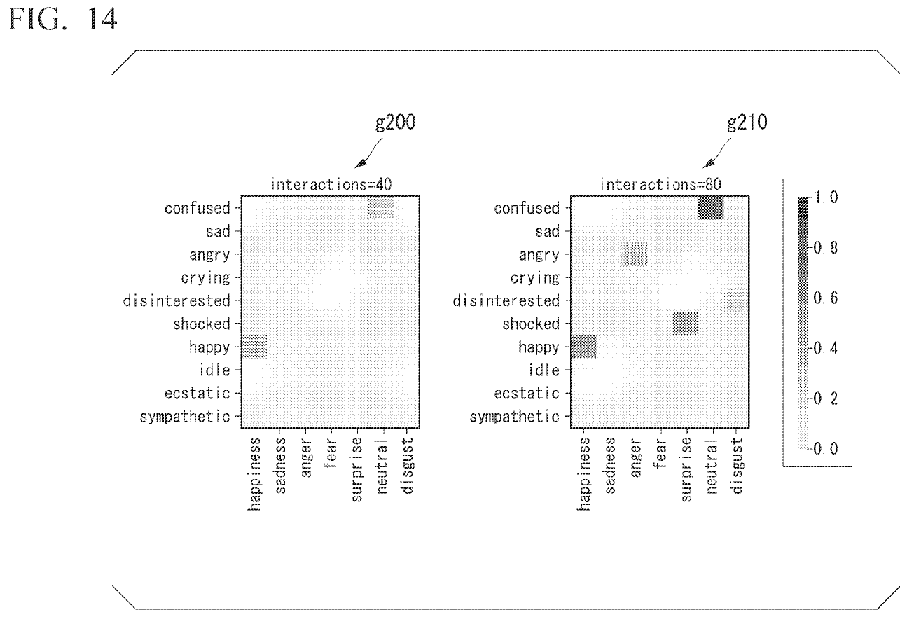

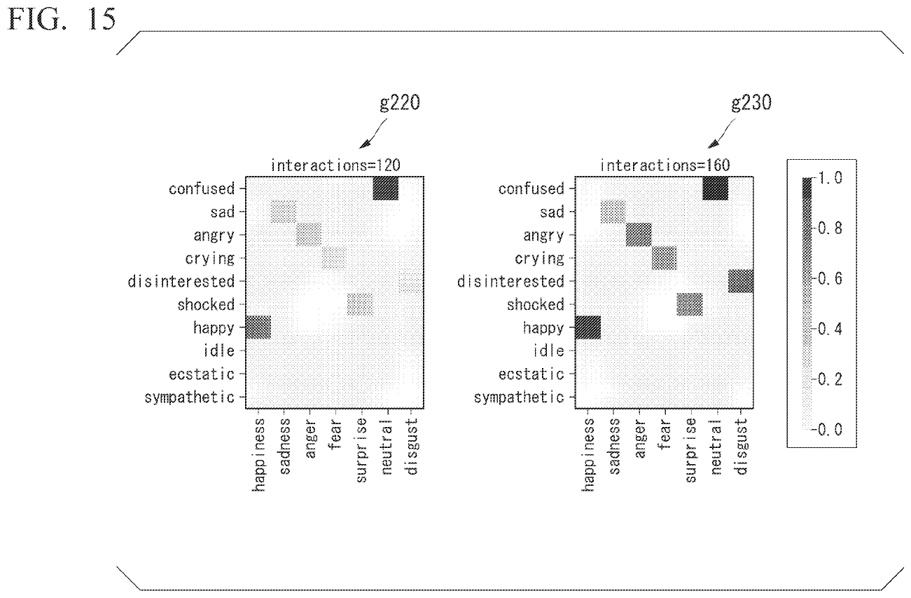

FIGS. 14 and 15 are heat maps learned by one user, visualizing the learning model (that is, the Q values of all emotional actions) in the facial emotional state for each of 40 interactions in the learning process. FIG. 14 shows a heat map (g200) with 40 interactions and a heat map (g210) with 80 interactions. FIG. 15 shows a heat map (g220) with 120 interactions and a heat map (g230) with 160 interactions.

In the heat maps shown in FIGS. 14 and 15, the horizontal axis represents the emotional states of seven faces (facial expressions) of a human user, and the vertical axis represents ten possible emotion routine actions in each state. Each block shows the Q value of the emotional action in one face state. For ease of comparison, all Q values were normalized to the same scale. As the color of the block becomes darker, the Q value increases.

During each interaction, the user implicitly performs facial feedback and the robot 1A updates the Q value. The routine action with the largest Q value will be selected by the robot 1A. That is, in a case where the robot 1A detects the same state in a new cycle, it will select the action with the darkest color in the heat map.

It can be understood that after 40 interactions, the robot 1A has learned the optimal emotional action for two of all facial emotional states (g200).

It can be understood that after 80 interactions, the robot 1A has already learned the optimal action for five of the seven states (g210).

It can be understood that after 120 interactions, the robot 1A has learned the final optimal policy for all seven facial states (g220).

It can be understood that after 160 interactions, the robot 1A has learned a stable optimal policy which is robust to misrecognition of implicit feedback because the Q value of the optimal action in each state is much larger (that is, darker) than other actions (g230).

The heat maps shown in FIGS. 14 and 15 are merely examples, and there is no limitation thereto.

(Implicit Feedback module)

Next, an implicit feedback module will be further described.

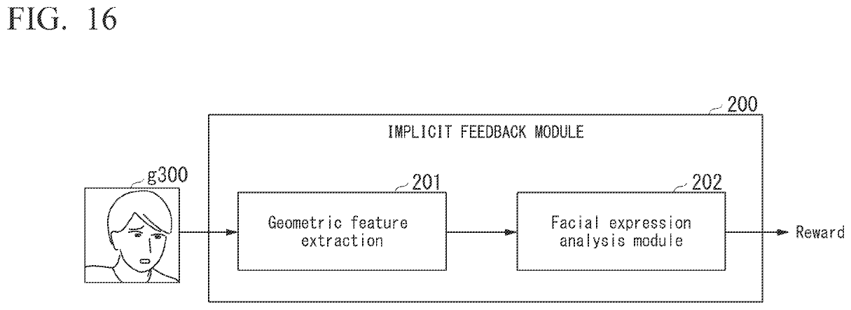

FIG. 15 is a diagram illustrating a configuration example of an implicit feedback module according to the present embodiment. As shown in FIG. 16, an implicit feedback module 200 includes, for example, a geometric feature extraction unit 201 and a facial expression analysis module 202.

The geometric feature extraction unit 201 extracts a geometric feature amount from the captured facial expression image using, for example, the trained CNN network described above. The geometric feature extraction unit 201 is included in the conversion unit 25.

The facial expression analysis module 202 inputs the geometric feature amount extracted by the geometric feature extraction unit 201 to, for example, the trained RNN network described above, estimates the user's emotion from the facial expression, and outputs a reward. The facial expression analysis module 202 is included in, for example, the emotion estimation unit 26.

### (Evaluation and Evaluation Results)

In the evaluation, for example, a MorphSet dataset was used for learning of the implicit feedback module. In the evaluation, a partial least squares (PLS) method was used for dimension reduction and prediction model learning.

Further, the evaluation conditions are the same as in the first embodiment, with the difference that continuous implicit feedback is used here.

In the evaluation, users were asked to imagine how they would like the robot 1A to react in various emotional states, and Haru was made to learn according to their own preferences. In the learning process, the robot 1A first detects the human emotional state, and then selects and executes an emotional action from a set of possible actions in each condition in accordance with the learned policy. The user observed the action of the robot 1A and performed facial feedback in accordance with his/her preferences. The robot 1A predicts implicit rewards and updates its policy on the basis of the received facial feedback.

For all emotional states in two conditions (see the evaluation of the first embodiment), a new cycle was allowed to start until the robot 1A learned the optimal action satisfied by the user. Due to time constraints and human physical endurance, the maximum number of interactions was 160 in the first condition with facial expressions as the emotional states, and 120 in the second condition with gestural expressions as the emotional states. The entire experiment time was approximately 25 minutes.

In each condition, users were asked to train two agents. One is an agent that learns from predicted implicit facial feedback, and the other is an agent that learns from explicit feedback. Both agents were compared with a third agent that learned from random feedback.

Learning based on explicit feedback is equivalent to making Haru learn with accuracy of 100% using predicted implicit facial feedback. Learning from random feedback is equivalent to making Haru learn with accuracy of 50% using predicted implicit facial feedback.

Explicit feedback was performed by pressing a button on the keyboard. In the evaluation, pressing “n” means that a positive reward is increased by +0.5, and pressing “v” means that a negative reward is increased by −0.5. Participants were allowed to perform feedback within three seconds after observing Haru's action. As implicit feedback, the user's reaction facial expression was acquired using a sensor, and the average recognition amount of ten consecutive frames (about 0.4 seconds) was used as predicted implicit feedback.

### (Selection of Latent Components for Implicit Feedback Prediction)

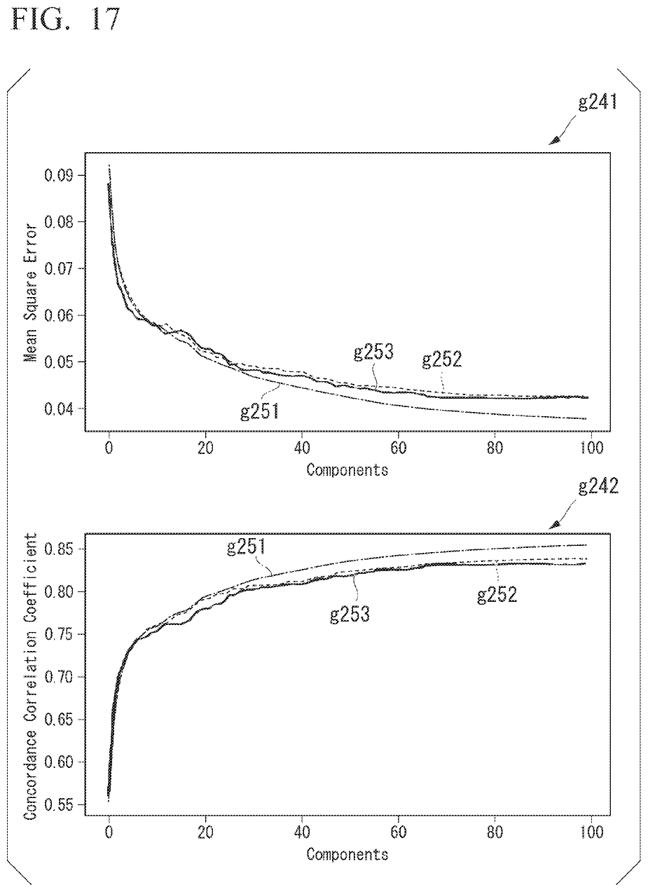

The number of latent components plays an important role in the prediction of continuous implicit feedback based on a partial least squares (PLS) method. A large number of latent components provides a good fit to the current data, but may result in overfitting, which makes the model less likely to be generalized with respect to new data. FIG. 17 is a diagram illustrating the mean square error (MSE) and concordance correlation coefficient (CCC) of implicit feedback prediction in a case where different numbers of latent components are retained in training, validation, test datasets. The graph of the reference sign g241 shows a change in the mean square error of the implicit feedback prediction with respect to the number of components. The graph of the reference sign g242 shows a change in the concordance correlation coefficient of the implicit feedback prediction with respect to the number of components. The line g251 is the result of training, the line g253 is the result of the validation dataset, and the line g253 is the result of the test dataset. The mean square error and concordance correlation coefficient are indices widely used to measure the performance of a dimensional emotion recognition method. A high concordance correlation coefficient value and a low mean square error value indicate good performance. Each learning curve is an average of data collected from ten users in each condition.

The goal is to select the minimum number of latent components in order to achieve good prediction accuracy. From FIG. 17, it can be understood that as the number of latent components to be retained increases, the mean square error of the training set, verification set, and test set decreases, and the concordance correlation coefficient increases. From FIG. 17, it can be understood that when the number of latent components reaches about 80, the mean square error becomes lowest and the concordance correlation coefficient reaches a peak. For this reason, in the evaluation, 81 latent components were selected for latent feedback prediction.

(Learning from Predicted Implicit Facial Feedback)

### I. Performance

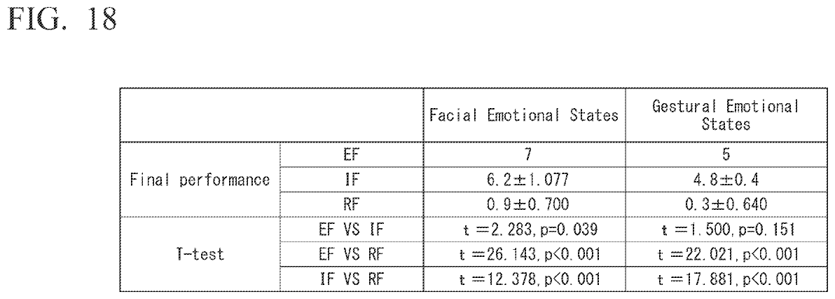

First, learning performance in two experimental conditions was analyzed by averaging the data collected from users in each condition. Welch's t-test was performed in order to examine the significance of the difference in learning performance due to three types of feedback in the two conditions. FIG. 18 is a diagram illustrating the average number of emotional states with optimal action and results of Welch's t-test for learning from explicit feedback, predicted implicit feedback, and random feedback. In FIG. 18, EF indicates explicit feedback, IF indicates implicit feedback, and RF indicates random feedback.

As shown in FIG. 18, the “final performance” represents the average number of optimal actions learned by the robot 1A from explicit feedback, implicit feedback, and random feedback in the two conditions. As shown in FIG. 18, it can be understood that the difference in learning performance between explicit feedback and implicit feedback is significant (r=0.039) in the condition involving the facial emotional state. However, learning performance from both explicit feedback and implicit feedback in both conditions was significantly better than random feedback.

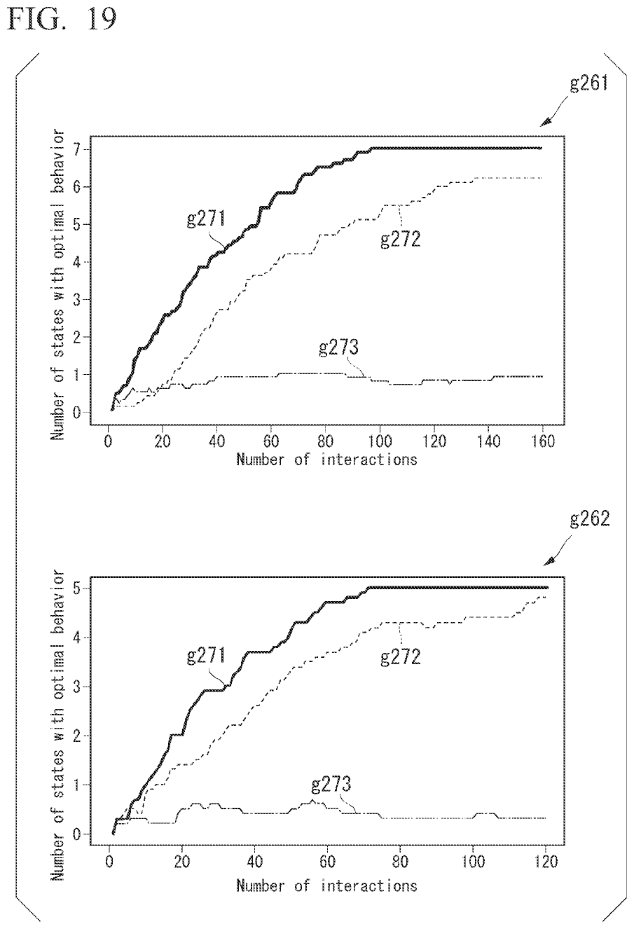

FIG. 19 is a diagram illustrating learning curves in which the emotional states of facial expressions and gestures are learned from predicted implicit feedback. From FIG. 19, it can be understood that, in learning from explicit feedback, Haru's performance increases rapidly and remains stable after about 100 interactions for the facial emotional state and after about 70 interactions for the gestural emotional state. That is, the evaluation results show that it can be understood that the optimal emotional action is obtained in all seven facial emotional states and five gestural emotional states. The evaluation results showed that learning based on continuous implicit feedback makes it possible to achieve performance similar to learning based on explicit feedback by quickly understanding and dynamically adapting to individual tendencies.

In the case of learning from random feedback, the learning performance of the robot 1A varies greatly and represents the worst case (prediction accuracy of 50%). Learning from both explicit feedback and implicit feedback was shown to be significantly better than learning from random feedback.

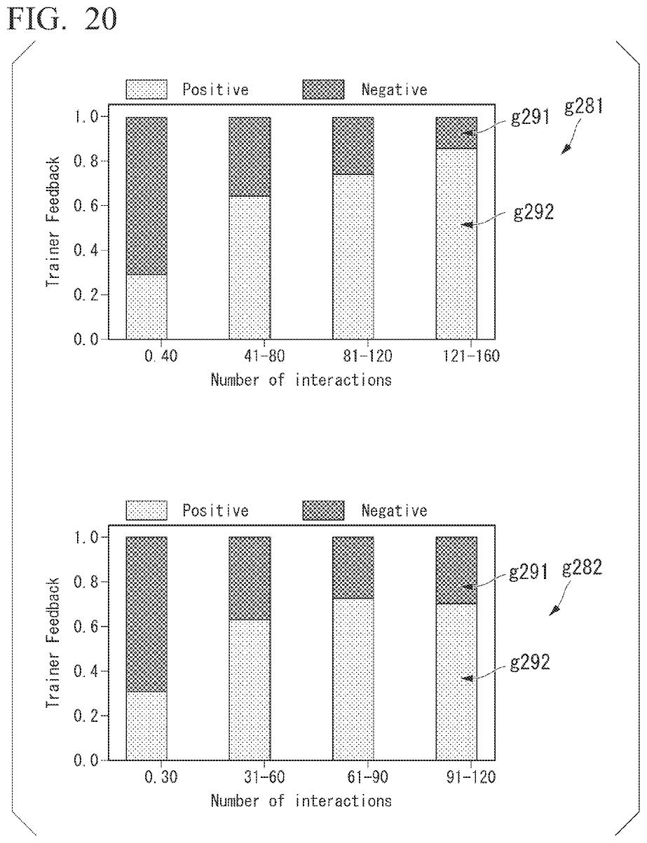

Next, the results of evaluating the number of implicit feedbacks performed by users in the two conditions during the process of training will be described. FIG. 20 is a diagram illustrating the proportion of positive and negative implicit feedback during a training process in two conditions using the emotional states of faces and gestures. Each plot is the average value of data collected from ten users in each condition. The reference sign g281 is the result in the training process in a case where facial expressions are used, and the reference sign g282 is the result in the training process in a case where gestures are used. In the reference signs g281 and g282, the horizontal axis represents the number of interactions, and the vertical axis represents the proportion of positive and negative implicit feedback. In the reference signs g281 and g282, the reference sign g291 indicates the proportion of negative implicit feedback, and the reference sign g292 indicates the proportion of positive implicit feedback.

From FIG. 20, it can be understood that the user tends to perform more negative feedback than positive feedback in the initial stage of training. After the policy of the robot 1A is improved, the proportion of negative feedback decreases and the proportion of positive feedback gradually increases. This is consistent with learning from explicit feedback and indicates that most of the implicit feedback was correctly interpreted by the prediction module of the present embodiment.

(Correlation with Continuous Implicit Feedback)

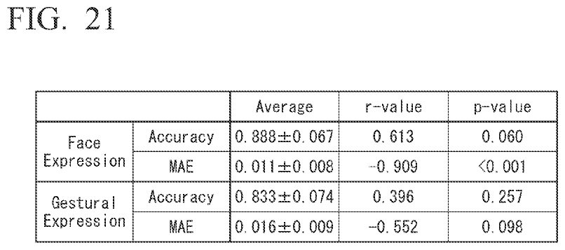

Next, the relationship between the prediction accuracy and mean absolute error (MAE) of continuous implicit feedback and Haru's performance was evaluated with the Pearson correlation test. FIG. 21 is a diagram illustrating a Pearson correlation between mean evaluation, standard deviation, mean absolute error (MAE), and Haru's learning performance for each condition.

As shown in FIG. 21, the average accuracy of implicit facial feedback prediction is μ=0.888 for the facial emotional state and μ=0.833 for the gestural emotional state, with a small variation in both conditions (σ=0.067 in the first condition and σ=0.074 in the second condition). The mean absolute error (MAE) of prediction of continuous implicit feedback in both conditions is also comparable (mean μ=0.011, standard deviation σ=0.008, μ=0.016, σ=0.009). From FIG. 21, it can be understood that the performance of the robot 1A has a positive correlation with prediction accuracy (r=0.613, p=0.059 in the first condition, and r=0.396, p=0.257 in the second condition), and has a high negative correlation with MAE (r=0.909, p<0.001 in the first condition for the facial emotional state, and r=−0.552, p=0.098 in the second condition for the gestural emotional state).

The evaluation results described above with reference to FIGS. 17 to 21 are merely examples, and there is no limitation thereto.

As described above, in the present embodiment, human-centered reinforcement learning is used to form the emotional action of the robot 1A while predicting continuous rewards on the basis of the received implicit facial feedback. In the present embodiment, by estimating the valence and arousal of implicit facial expression feedback acquired using Russell's emotional circle model, it was possible to more accurately estimate subtle human psychological changes, and to realize more effective robot action learning. The evaluation results confirm that by using the method of the present embodiment, the robot 1A can obtain the same performance as learning from explicit feedback, and that a human user does not need to become familiar with the learning interface in advance, which makes it possible to realize an unobtrusive learning process.

A program for realizing all or some of the functions of the emotion acquisition device 11 (or 11A) in the present invention may be recorded in a computer-readable recording medium, and the program recorded in this recording medium may be read into a computer system and executed to perform all or some of the processes performed by the emotion acquisition device 11 (or 11A). The “computer system” referred to here is assumed to include an OS and hardware such as peripheral devices. The “computer system” is also assumed to include a WWW system provided with a homepage providing environment (or a display environment). The term “computer readable recording medium” refers to a flexible disk, a magneto-optic disc, a ROM, a portable medium such as a CD-ROM, and a storage device such as a hard disk built into the computer system. Further, the “computer readable recording medium” is assumed to include recording mediums that hold a program for a certain period of time like a volatile memory (RAM) inside a computer system serving as a server or a client in a case where a program is transmitted through networks such as the Internet or communication lines such as a telephone line.

The above-mentioned program may be transmitted from a computer system having this program stored in a storage device or the like through a transmission medium or through transmitted waves in the transmission medium to other computer systems. Here, the “transmission medium” that transmits a program refers to a medium having a function of transmitting information like networks (communication networks) such as the Internet or communication channels (communication lines) such as a telephone line. The above-mentioned program may realize a portion of the above-mentioned functions. Further, the program may be a so-called difference file (difference program) capable of realizing the above-mentioned functions by a combination with a program which is already recorded in a computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An emotion acquisition device comprising:
an image capturing unit that acquires a human facial expression;
a conversion unit that converts the human facial expression acquired by the image capturing unit into a continuous value indicating a human emotion; and
an emotion estimation unit that maps the continuous value converted by the conversion unit to estimate an emotion of a target person.

2. The emotion acquisition device according to claim 1, wherein the emotion estimation unit estimates an emotion of a target person by mapping continuous values using Russell's emotional circle model.

3. The emotion acquisition device according to claim 1, wherein the conversion unit uses a CNN network to extract a feature amount of an image which is a continuous value from the image of the acquired human facial expression.

4. The emotion acquisition device according to claim 3, wherein the emotion estimation unit inputs the continuous value indicating the human emotion converted by the conversion unit into an RNN network to obtain a reward depending on whether the facial expression of the target person is positive or negative.

5. The emotion acquisition device according to claim 1, wherein the emotion estimation unit updates a Q value in Q-learning using the following equation each time the human emotion is acquired,
$${Q ( {s}_{t} , {a}_{t} )}_{new} = {Q ( {s}_{t} , {a}_{t} )}_{old} + α ( {R}_{h} + γ {max}_{a} Q ( {s}^{′} , a ) - Q ( {s}_{t} , {a}_{t} ) )$$
where sₜ and aₜ are an emotional state detected by and an emotional action selected by a robot at time step t, respectively, α is a learning rate, Rₕ is a reward and predicted implicit feedback, and s′ is a next state.

6. The emotion acquisition device according to claim 5, wherein the reward Rₕ is calculated by the following equation,
$${R}_{h} = \{ \begin{matrix}\frac{2 - [ {( V - 1 )}^{2} + {( A - 1 )}^{2} ]}{2} & V > 0 , A > 0 \\ - \frac{1}{2} * \frac{2 - [ {V}^{2} + {( A - 1 )}^{2} ]}{2} & V \leq 0 , A > 0 \\ - \frac{2 - [ {V}^{2} + {A}^{2} ]}{2} & V \leq 0 , A \leq 0 \\ \frac{1}{2} * \frac{2 - [ {( V - 1 )}^{2} + {A}^{2} ]}{2} & V > 0 , A \leq 0\end{matrix}$$
where V is an estimated valence and A is an estimated arousal value.

7. An emotion acquisition method comprising:
causing an image capturing unit to acquire a human facial expression;
causing a conversion unit to convert the human facial expression acquired by the image capturing unit into a continuous value indicating a human emotion; and
causing an emotion estimation unit to map the continuous value converted by the conversion unit to estimate an emotion of a target person.

8. A computer readable non-transitory storage medium having a program stored therein, the program causing a computer of an emotion acquisition device to:
acquire a human facial expression;
convert the acquired human facial expression into a continuous value indicating a human emotion; and
map the converted continuous value to estimate an emotion of a target person.
